(19) United States
(12) Patent Application Publication
(10) Pub. No.: US 2014/0339818 A1
(43) Pub. Date: Nov. 20, 2014

(54) CONNECTION SYSTEM FOR PIPES IN REFRIGERATION PLANTS

(71) Applicant: Olab S.R.L., Torbole Casaglia (IT)

(72) Inventor: Cesare Bottura, Brescia (IT)

(73) Assignee: Olab S.R.L., Torbole Casaglia (IT)

(21) Appl. No.: 14/275,800

(22) Filed: May 12, 2014

(30) Foreign Application Priority Data
May 15, 2013 (IT) MI2013U000191

(51) Int. Cl. F16L 13/02

(52) U.S. Cl. CPC F16L 13/02
USPC 285/288.5

(57) ABSTRACT

A connection system for pipes in refrigeration plants, comprising an adapter that is adapted to enable the connection of a pipe to a device that is adapted to be used in a refrigeration plant, the adapter being provided with a groove that is adapted to prevent the extraction of the adapter from a connection portion of the device, the groove being adapted to be engaged by a conical locking ring that forms part of the connection portion of the device.

The present invention relates to a connection system for pipes in refrigeration plants. More specifically, the invention relates to a system for connecting several devices that are used in refrigeration plants.

### BACKGROUND OF THE INVENTION

As is known, the term “refrigeration plant” means a particular system of apparatuses and/or devices, the task of which is to lower the temperature of the environment and maintain it at relatively low levels.

Such devices are connected to each other, within the plant, by way of interposition of copper pipes and two different types of connection between the several elements of the system can be identified.

A first type of connection is provided by way of SAE flare threaded couplings, and a second type of connection is by way of welding.

The first type of connection assumes that the end of the pipe to be connected undergoes a particular operation called “flaring”.

After the flaring operation, the end of the pipe will be flared at 45° and the seal of the piping occurs by compression of the flared portion of pipe between the end of a male connector, which is also inclined at 45°, and an inlet that engages by way of a threading with the male connector.

The male connector that engages with the inlet can also be provided at the inlet or at the outlet of elements such as solenoid valves, ball valves, safety valves and the like, thus enabling connection with the pipes of such devices.

The second type of connection is by way of operations to weld the pipe (which is usually made of copper).

Welding assumes the presence of an adapted seat called “welding socket” into which the copper pipe that needs to be connected is inserted and then welded.

The welding socket can be provided on elements such as connectors, solenoid valves, ball valves, and the like.

Both types of connection described above suffer drawbacks that can determine some potential problems as a consequence of their use.

Firstly, with regard to the SAE flare connection, it is necessary to provide the flaring of the pipe before being able to execute the connection of the piping, and this flaring operation must be carried out correctly in order to prevent leaks in the connection.

Furthermore, it is necessary to use pipes that have the inner and outer surfaces free from scoring, since the compression of the pipe between connector and inlet may not be sufficient to ensure the seal of the connection.

Also and furthermore, it is necessary to screw the inlet with a high tightening force in order to be able to provide the dry seal between connector, pipe, and inlet.

With regard to the connection by welding, the welding operation that is necessary for the connection of the two elements (solenoid valve and pipe, for example) involves an application of heat which is propagated through the devices that need to be welded. This can cause damage to some components such as the sealing gaskets that are present in the devices themselves. Usually, in order to prevent these problems, the assembly technicians position wet rags on the device to be protected and carry out the welding, stopping from time to time in order to limit the propagation of the heat.

Furthermore, the components that are assembled on the pipes by welding cannot be replaced without cutting the pipes. Thus, if it is desired to substitute a solenoid valve, it will be necessary to cut the connecting pipe and insert another solenoid valve, and execute the connecting weld again.

The solenoid valves furthermore must always be supplied to the assembly technicians without coils, since during the welding operation the solenoid could be damaged. This involves the installation technicians spending extra time, since they have to mount the coil on the valve body at another time.

Finally, the welding must always be carried out by qualified technicians.

### SUMMARY OF THE INVENTION

The aim of the present invention is to provide a connection system for pipes in refrigeration plants, which makes it possible to connect the several devices used in refrigeration plants, without resorting to traditional connection systems, while ensuring the high performance levels required by the sector.

Within this aim, an object of the present invention is to provide a connection system for pipes in refrigeration plants which makes it possible to avoid executing the flaring before providing the connection.

Another object of the present invention is to provide a connection system for pipes in refrigeration plants which does not necessarily require pipes with a good inner surface finish.

Another object of the present invention is to provide a connection system for pipes in refrigeration plants which enables a simple substitution of the device that is connected to the plant, without requiring the pipes to be cut.

Another object of the present invention is to provide a connection system for pipes in refrigeration plants which makes it possible to supply solenoid valves with coils already mounted, since they cannot be damaged during the mounting operations.

Another object of the present invention is to provide a connection system for pipes in refrigeration plants which is highly reliable, easily and practically implemented and low cost.

This aim and these and other objects which will become better apparent hereinafter are achieved by a connection system for pipes in refrigeration plants, comprising an adapter that is adapted to enable the connection of a pipe to a device that is adapted to be used in a refrigeration plant, characterized in that said adapter is provided with a groove that is adapted to prevent the extraction of said adapter from a connection portion of said device, said groove being adapted to be engaged by a conical locking ring that forms part of said connector.

### BRIEF DESCRIPTION OF THE DRAWINGS

Further characteristics and advantages of the invention will become better apparent from the description of a preferred, but not exclusive, embodiment of the connection system according to the present invention, which is illustrated by way of non-limiting example in the accompanying drawings wherein:

FIG. 1 is an exploded, sectional view of the connection system according to the present invention;

FIG. 2 is a sectional view of an enlarged detail of FIG. 1;

FIG. 3 is an exploded, sectional view of the connection system according to the invention, showing a weld seam between the adapter and the connecting pipe;

FIG. 4 is a sectional view of an enlarged detail of a particular point of FIG. 3;

FIG. 5 is a sectional view of the connection system according to the invention, in the coupled condition;

FIG. 6 is a sectional view of an enlarged detail of a particular point of FIG. 5;

FIG. 7 is a sectional view of an enlarged detail of a particular point of FIG. 5;

FIG. 8 is a sectional view of a detail of FIG. 1.

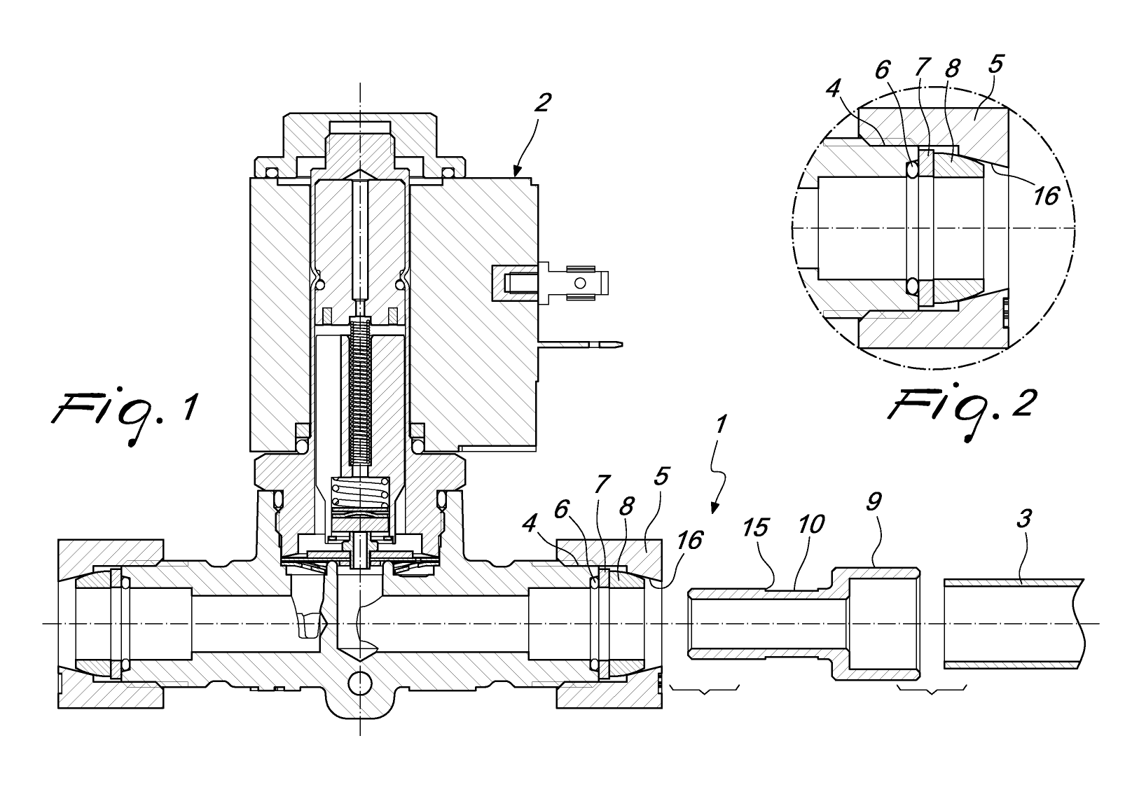

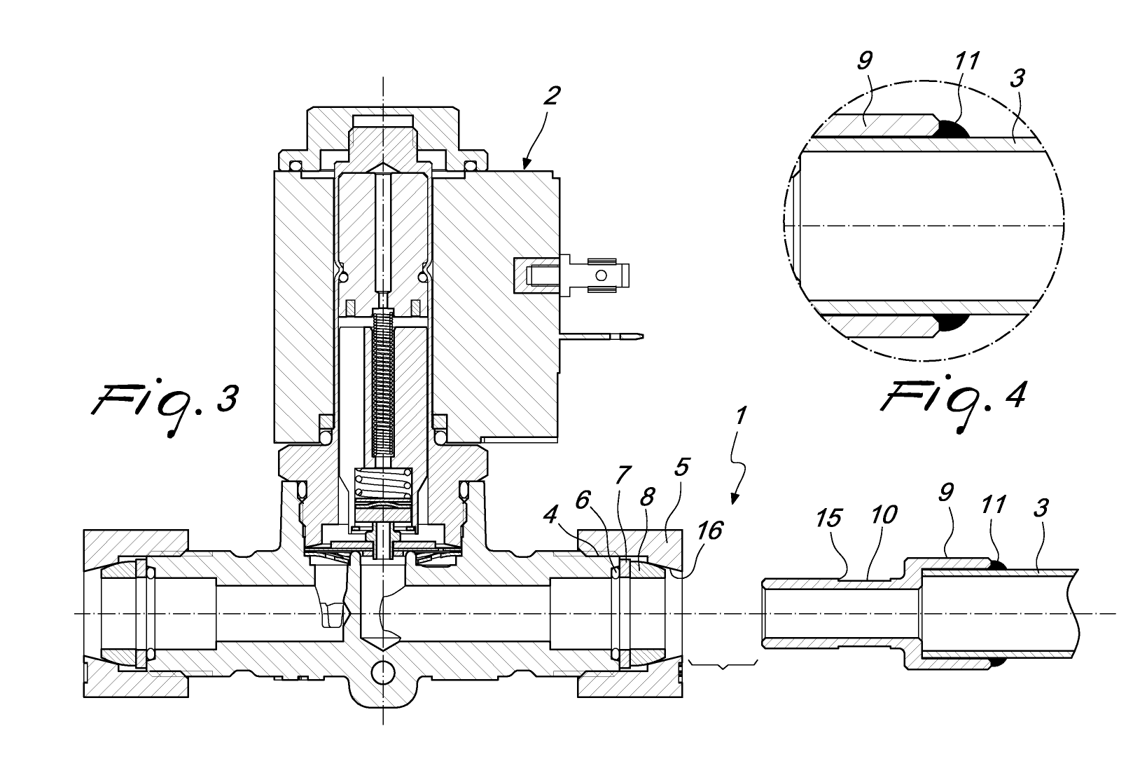

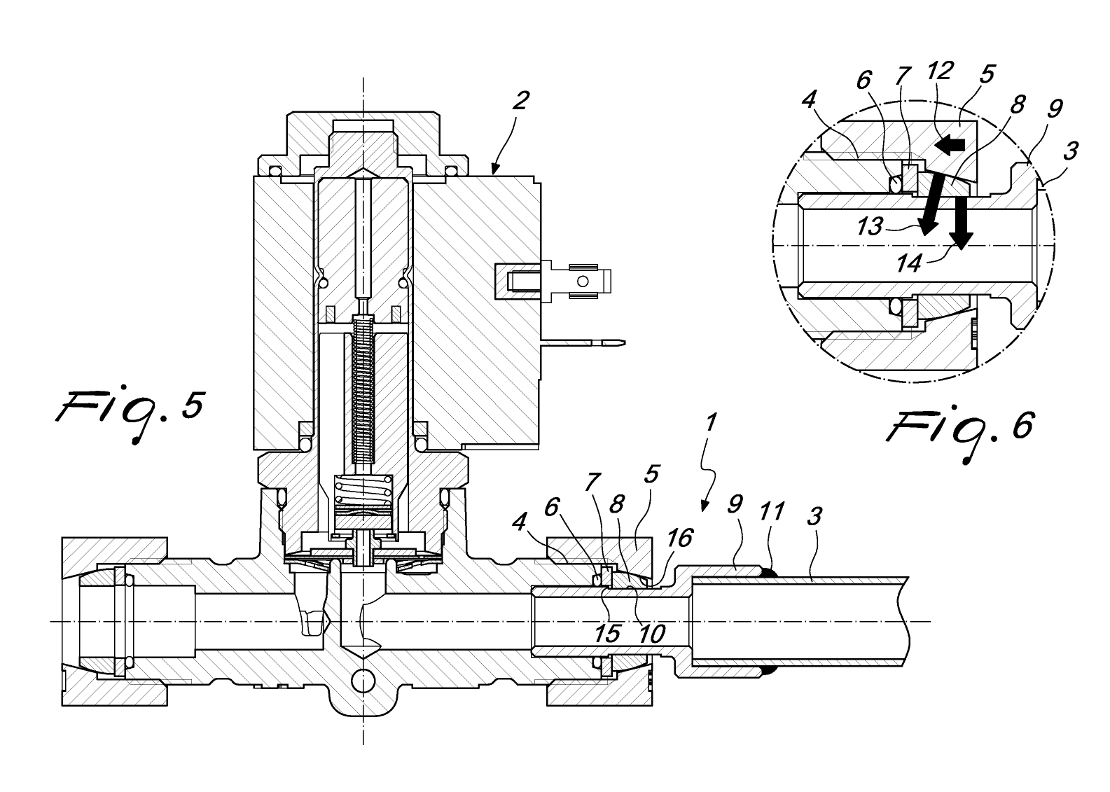

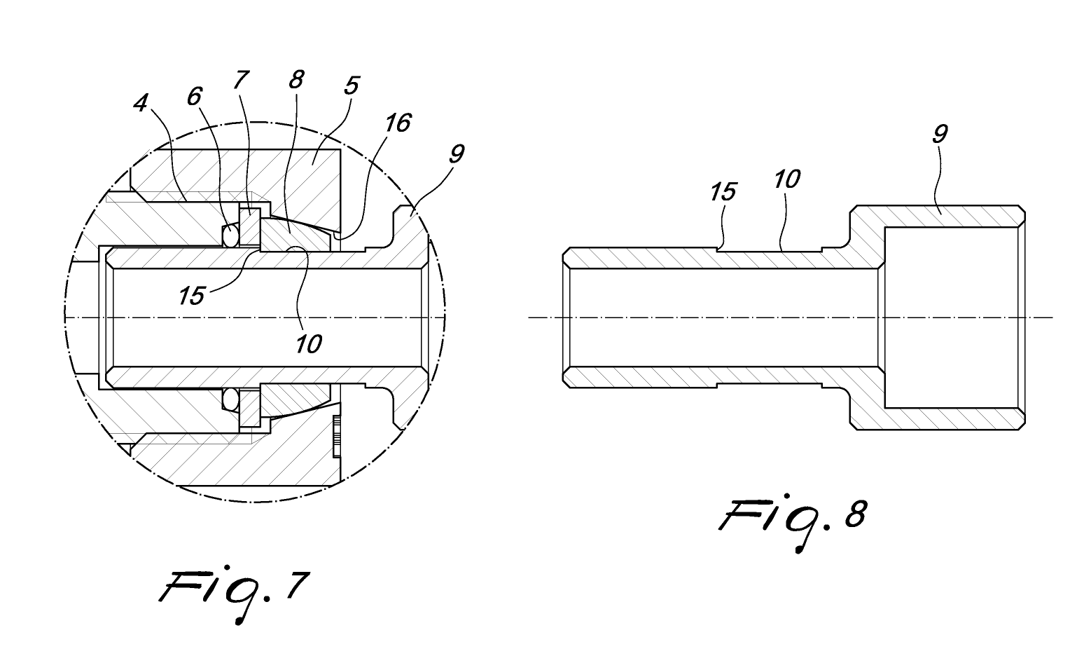

### DESCRIPTION OF THE PREFERRED EMBODIMENTS

With reference to the figures, the connection system according to the invention, which is generally designated by the reference numeral 1, comprises, for the connection to a solenoid valve, ball valve, faucet, safety valve, which is designated for the purposes of example by the reference numeral 2, an adapter 9 that enables the connection to a pipe 3, usually made of copper, the adapter, once connected to the pipe 3, must be connected to an end or to a connection portion of the device 2.

In essence, the device 2 is provided with a threaded end 4 onto which is screwed a nut 5, which is screwed against a truncated conical ring 8, below which is interposed a washer 7 that rests on a gasket seal 6.

Conveniently, the adapter 9 is provided with a retaining groove 10 that makes it possible, once the adapter 9 is inserted in the threaded end of the device 2, to engage with the truncated conical ring 8, which abuts against a step or edge 15 of the groove 10 of the adapter 9.

In this manner, a retaining action of the adapter 9 by the threaded end of the device 2 is obtained.

Therefore, the function of the truncated conical ring 8 is to lock the adapter 9 that is inserted in the connector (connection portion) that is defined at the end of the device 2.

Operation is therefore the following.

The connecting pipe 3, which is usually made of copper, is inserted in an adapted seat provided on the adapter 9 and is welded by way of a weld seam 11 so as to render it integral with the adapter 9. This connection operation between the pipe 3 and the adapter 9 is carried out with the adapter disconnected from the connector. Once the welding of the pipe 3 to the adapter 9 has been carried out, the latter is inserted in the truncated conical ring connector and, while keeping it in abutment internally, the nut 5 is screwed with an adapted tightening torque.

By way of the screwing of the nut 5, which is provided internally with an inclined surface 16, which acts on the conicity of the truncated conical ring 8, such conical ring is closed onto the adapter 9, thus coupling the adapter to the device 2.

FIG. 6 shows the breakdown of the tightening force of the nut 5 in its radial component 14, which compresses the adapter and prevents its extraction, and its axial component 12, which places the threading under traction, thus preventing the nut 5 from being unscrewed.

The reference numeral 13 designates the locking action exerted by the inclined surface 16 of the nut 5 on the truncated conical ring 8.

The adapter 9 can be smooth or it can have a reduction in diameter at the conical locking ring 8. With the groove 10, the retaining effect of the adapter 9 is amplified by way of the presence of the step 15 which acts as a holdback against the extraction of the adapter 9.

The connection system according to the invention means, unlike the first conventional type of connection described above, that it is not necessary to execute the flaring of the pipe before the connection is made, thus reducing the problems of leakage owing to badly-executed flaring.

Furthermore, it is not necessary to specifically use pipes with a good inner surface finish.

Finally, when tightening the nut it is not necessary to use torque levels that are too high, since the adapter is provided with the retaining groove and the connection is not obtained by compression between the connector and the inlet of the flared portion of pipe, but rather by way of a gasket (O-ring).

Compared with the second type of connection, the advantages of the solution according to the invention are constituted by the fact that the connection of the pipe to the adapter is executed with the elements disconnected from the device, thus avoiding the overheating of and damage to the components of the device by way of the transmission of heat from welding.

Therefore, the welding can be carried out without interruptions and it is not necessary to employ traditional methods such as wet rags in order to cool the devices that need to be welded.

Furthermore, the weld seam can be more considerable and can ensure a better hold between the pipe and the adapter, since the welding technician can continue heating the two pieces without interruption.

Another advantage is constituted by the fact that it is very simple to substitute the device in the plant; in fact by unscrewing the nut of the truncated conical ring connector it is possible to extract the adapter from the device and substitute it with a new one.

In the absence of the solution according to the invention, the pipes have to be cut and welds of connection pipes to the device must be executed again.

Finally, solenoid valves can be supplied to the customer with the coil mounted, since the coil cannot be damaged during the welding process. This results in a saving of time in the subsequent assembly.

In practice it has been found that the connection system according to the present invention fully achieves the set aim and objects.

The connection system, thus conceived, is susceptible of numerous modifications and variations, all of which are within the scope of the appended claims.

Moreover, all the details may be substituted by other, technically equivalent elements.

In practice the materials employed, and the contingent dimensions and shapes, may be any according to requirements and to the state of the art.

The disclosures in Italian Utility Model Application No. MI2013U000191 from which this application claims priority are incorporated herein by reference.

What is claimed is:

1. A connection system for pipes in refrigeration plants, comprising an adapter that is adapted to enable the connection of a pipe to a device that is adapted to be used in a refrigeration plant, wherein said adapter is provided with a groove that is adapted to prevent the extraction of said adapter from a connection portion of said device, said groove being adapted to be engaged by a conical locking ring that forms part of said connection portion of the device.

2. The connection system according to claim 1, wherein said pipe is welded to said adapter.

3. The connection system according to claim 1, wherein said adapter is screwed into said connector by way of a lock nut.

4. The connection system according to claim 1, wherein said groove is defined circumferentially by a surface of said adapter.

5. A method for connecting a pipe of a refrigeration plant to a device that is present in said refrigeration plant, comprising the steps of:
coupling said pipe to an adapter, by carrying out a weld so as to render said pipe integral with said adapter;
inserting said adapter in a connection portion of said device;
tightening a nut of said connector so as to lock said adapter inside said connector;
the inner surface of said nut effecting a compression on a truncated conical ring of said connection portion, which in turn couples and engages in a groove defined on the surface of said adapter.
